(19) United States
(12) Patent Application Publication
(10) Pub. No.: US 2017/0144092 A1
(43) Pub. Date: May 25, 2017

(54) CENTRIFUGAL ABATEMENT APPARATUS

(71) Applicant: Edwards Limited, Burgess Hill, West Sussex (GB)

(72) Inventor: Andrew James SEELEY, Bristol (GB)

(21) Appl. No.: 15/327,407

(22) PCT Filed: Jul. 20, 2015
(86) PCT No.: PCT/GB2015/052091

§ 371 Date: Jan. 19, 2017

(30) Foreign Application Priority Data
Jul. 21, 2014 (GB) 1412877.1

(51) Int. Cl. B01D 45/14; B01D 47/14; B01D 47/16; B04B 5/08; B01D 53/18; B01D 53/14; B04B 5/10; B04B 5/12; B01D 47/06; B01D 50/00

(52) U.S. Cl. CPC B01D 45/14; B01D 47/06; B01D 47/14; B01D 47/16; B01D 50/004; B01D 53/18; B01D 53/1456; B04B 5/10; B04B 5/12; B04B 5/08; B01D 2252/103

(57) ABSTRACT

An abatement apparatus and method are disclosed. The abatement apparatus for treating an effluent stream from a semiconductor processing tool comprises: a first treatment stage operable to combust the effluent stream to provide a combusted effluent steam and to treat the combusted effluent stream with water to provide a first stage treated effluent stream comprising treated fluid together with combustion particles and water; and a second treatment stage operable to receive the first stage treated effluent stream at an inlet and to separate centrifugally at least some of the combustion particles and the water from the treated fluid which is provided at a treated fluid outlet as a second stage treated effluent stream. In this way, particles and water may be removed effectively from the combusted effluent stream without the need for an inconvenient electrostatic precipitator. Instead, the second treatment stage provides for improved particle capture within a smaller footprint. Also, utilising water helps to retain the particles separately from the treated fluid.

This application is a national stage entry under 35 U.S.C. §371 of International Application No. PCT/GB2015/052091, filed Jul. 20, 2015, the entire content of which is incorporated herein by reference.

### TECHNICAL FIELD OF THE INVENTION

The present invention relates to an abatement apparatus and method. Embodiments relate to an abatement apparatus for treating an effluent stream containing solid particles such as, for example, SiO₂ and acidic gases such as HCl.

### BACKGROUND OF THE INVENTION

Gas treatment apparatus are known. Such apparatus are used for treatment of effluent gases arising from epitaxial deposition processes. Epitaxial deposition processes are increasingly used for high-speed semiconductor devices, both for silicon and compound semiconductor applications. An epitaxial layer is a carefully grown, single crystal silicon film. Epitaxial deposition utilizes a silicon source gas, typically silane or one of the chlorosilane compounds, such as trichlorosilane or dichlorosilane, in a hydrogen atmosphere at high temperature, typically around 800-1100° C., and under a vacuum condition. Epitaxial deposition processes are often doped with small amounts of boron, phosphorus, arsenic, germanium or carbon, as required, for the device being fabricated. Etching gases supplied to a process chamber may include halocompounds such as HCl, HBr, BCl₃, Cl₂ and Br₂, and combinations thereof. Hydrogen chloride (HCl) or another halocompound, such as SF₆ or NF₃, may be used to clean the chamber between process runs.

In such processes, only a small proportion of the gas supplied to the process chamber is consumed within the chamber, and so a high proportion of the gas supplied to the chamber is exhausted from the chamber, together with solid and gaseous by-products from the process occurring within the chamber. A process tool typically has a plurality of process chambers, each of which may be at respective different stage in a deposition, etching or cleaning process. Therefore, during processing a waste effluent stream formed from a combination of the gases exhausted from the chambers may have various different compositions.

Before the waste stream is vented into the atmosphere, it is treated to remove selected gases and solid particles therefrom. Acid gases such as HF and HCl are commonly removed from a gas stream using a packed tower scrubber, in which the acid gases are taken into solution by a scrubbing liquid flowing through the scrubber. Silane is pyrophoric, and so before the waste stream is conveyed through the scrubber it is common practice for the waste stream to be conveyed through a thermal incinerator to react silane or other pyrophoric gas present within the waste stream with air. Any perfluorocompounds such as NF₃ may also be converted into HF within the incinerator.

When silane burns, large amounts of silica (SiO₂) particles are generated. Whilst many of these particles may be taken into suspension by the scrubbing liquid within the packed tower scrubber, it has been observed that the capture of relatively smaller particles (for example, having a size less than micron) by the scrubbing liquid is relatively poor. In view of this, it is known to provide an electrostatic precipitator downstream from the scrubber to remove these smaller particles from the waste stream.

Although such apparatus provide for treatment of the effluent gas stream, they have a number of shortcomings. Accordingly, it is desired to provide an improved gas treatment apparatus.

### SUMMARY OF THE INVENTION

According to a first aspect, there is provided an abatement apparatus for treating an effluent stream from a semiconductor processing tool, comprising: a first treatment stage operable to combust the effluent stream to provide a combusted effluent steam and to treat the combusted effluent stream with water to provide a first stage treated effluent stream comprising treated fluid together with combustion particles and water; and a second treatment stage operable to receive the first stage treated effluent stream at an inlet and to separate centrifugally at least some of the combustion particles and the water from the treated fluid which is provided at a treated fluid outlet as a second stage treated effluent stream.

The first aspect recognises that using electrostatic precipitators to capture and remove particles is inconvenient since to be effective they need to be large and operate at high voltage (typically 25 kV). Accordingly, an abatement apparatus is provided. The apparatus may treat an effluent stream from, for example, a semiconductor processing tool. The apparatus may comprise a first treatment stage. The first treatment stage may combust the effluent stream to produce a combusted effluent stream. The first treatment stage may also treat the combusted effluent stream with water to produce a first stage effluent treated stream. The first stage treated effluent stream may comprise a treated fluid, together with combustion particles and water. The apparatus may also comprise a second treatment stage. The second treatment stage may receive the first stage treated effluent stream at the inlet. The second treatment stage may separate centrifugally combustion particles and water from the treated fluid. The treated fluid absent the removed combustion particles and water may be provided at a treated fluid outlet as a second stage treated effluent stream. In this way, particles and water may be removed effectively from the combusted effluent stream without the need for an inconvenient electrostatic precipitator. Instead, the second treatment stage provides for improved particle capture within a smaller footprint. Also, utilising water helps to retain the particles separately from the treated fluid.

In one embodiment, the second treatment stage comprises a centrifugal separator having the inlet coupled with the first treatment stage for receiving the first stage treated effluent stream, the treated fluid outlet for providing the second stage treated effluent stream and a particle outlet for providing the combustion particles and the water separated from the treated fluid. Hence, a centrifugal separator may be provided which receives the first stage treated effluent stream and, as well as the treated fluid outlet, has a particle outlet which provides the removed combustion particles and water which have been separated from the treated fluid.

In one embodiment, the centrifugal separator comprises a cylindrical chamber defined by a base plate and an opposing plate coupled by a rim. It will be appreciated that the distance between the opposing plates may be significantly less than the diameter of those opposing plates, which provides for a particularly compact arrangement.

In one embodiment, the centrifugal separator is operable to receive the first stage treated effluent stream at the inlet centrally-located in the opposing plate. Providing the inlet centrally within the plate helps to maximise the centrifugal separation and avoids complicated feeds.

In one embodiment, the particle outlet in the base plate is operable to drain the particles and the water into a sump. Accordingly, the particles and water may be removed under gravity.

In one embodiment the treated fluid outlet in the opposing plate is operable to vent the treated fluid. Accordingly, the treated fluid may vent or exhaust from the centrifugal separator under pressure.

In one embodiment the particle outlet and the treated fluid outlet are located radially away from the inlet.

In one embodiment, the second treatment stage comprises at least one of a radial fan and a centrifugal particle separator. Accordingly, a radial fan, a centrifugal particle separator, or both, may be provided to perform the centrifugal separation of the particles and/or water from the treated fluid.

In one embodiment, the radial fan is rotatable and comprises a plurality of vanes extending from the inlet towards the rim.

In one embodiment the vanes taper towards the rim. Providing tapering towards the rim reduces the turbulent flow in the vicinity of the rim.

In one embodiment, the vanes terminate prior to the rim to define a volute within which the first stage treated effluent stream accelerated by the vanes is received. Hence, the first stage treated effluent gas stream may be received within a volute defined between the ends of the vanes and the rim.

In one embodiment, walls of the volute are operable to entrain the combustion particles and the water to separate the combustion particles and the water from the treated fluid. Accordingly, the combustion particles and water may be received and retained by the walls in order to separate them from the treated fluid.

In one embodiment, the particle outlet is provided proximate at least one of the rim and an end of the vane. Hence, the particle outlet is provided in the vicinity of the location where the particles gather.

In one embodiment, the treated fluid outlet is provided proximate at least one of the rim and an end of the vane.

In one embodiment, the centrifugal particle separator is rotatable and comprises a plurality of conduits extending axially proximate the rim to receive the first stage treated effluent stream. Accordingly, the centrifugal particle separator may be formed by conduits which extend along the axis of rotation of the centrifugal particle separator near its rim and which receive the first stage treated effluent stream. Hence, the conduits may be aligned with the axis of rotation of the centrifugal particle separator.

In one embodiment, a wall of the conduit is operable to entrain the combustion particles and the water to separate the combustion particles and the water from the treated fluid during rotation of the conduit as the first stage treated effluent stream is conveyed therethrough. Accordingly, the walls of the conduits receive and retain the combustion particles and water as the first stage treated effluent stream passes through those conduits.

In one embodiment, each conduit comprises a conduit inlet for receiving the first stage treated effluent stream and a conduit outlet as the outlet for venting the treated fluid, the combustion particles and the water entrained by the wall draining back through the inlet. Accordingly, the separated combustion particles and water drain back out of each conduit through its inlet.

In one embodiment, the conduits are formed within an annular body extending along the rim. Hence, the conduits are formed within a ring which extends from the rim.

In one embodiment, the second treatment stage comprises both the radial fan and the centrifugal particle separator. Providing both the radial fan and the centrifugal particle separator enhances the separation performance of the second treatment stage.

In one embodiment, treated fluid separated from the combustion particles and the water entrained by the walls of the volute of the radial fan is conveyed to conduits of the centrifugal particle separator. Accordingly, the radial fan may perform the initial separation and the centrifugal particle separator may perform subsequent separation.

In one embodiment, the vanes and conduits are dimensioned to match a fluid velocity within the volute with a fluid velocity within the conduits. This helps to reduce turbulence.

In one embodiment, the apparatus comprises a drive operable to rotate the centrifugal separator.

In one embodiment, the treated fluid outlet is coupled with a third treatment stage for treating the second stage treated effluent stream.

In one embodiment, the first treatment stage, the second treatment stage and the third treatment stage are co-axially located. This helps to provide a compact arrangement.

In one embodiment, the third treatment stage co-axially surrounds the first treatment stage. This helps to provide a particularly compact arrangement.

In one embodiment, the first treatment stage, the second treatment stage and the third treatment stage are received within a common housing.

In one embodiment, a tolerance between the inlet and the first treatment stage is dimensioned to be packed by water to provide a rotational seal. Hence, the water may also be utilised to provide a rotational seal.

In one embodiment, the first treatment stage comprises a burner and water cooler.

In one embodiment, the third treatment stage comprises an acid scrubbing chamber.

In one embodiment, the treated fluid outlet provides the second stage treated effluent gas stream to a base of the acid scrubbing chamber.

In one embodiment, the opposing plate comprises drain holes operable to drain water from the third treatment stage into the second treatment stage. Hence, water draining from the third treatment stage then flows back into the second treatment stage for removal of it and any entrained combustion particles.

In one embodiment, the abatement apparatus is operable to convey the first stage treated effluent gas stream under pressure from the first treatment stage through the second treatment stage.

In one embodiment, the apparatus comprises a pump operable to pump water received from the particle outlet to at least one of the first treatment stage, the third treatment stage and to a bearing supporting the second treatment stage. Accordingly, the same drive and water can be used for multiple purposes.

According to a second aspect, there is provided a method of treating an effluent stream from a semiconductor processing tool, comprising: combusting, at a first treatment stage, the effluent stream to provide a combusted effluent steam and treating the combusted effluent stream with water to provide a first stage treated effluent stream comprising treated fluid together with combustion particles and water; and receiving, at a second treatment stage, the first stage treated effluent stream at an inlet and separating centrifugally at least some of the combustion particles and the water from the treated fluid and providing the treated fluid at a treated fluid outlet as a second stage treated effluent stream.

In one embodiment, the second treatment stage comprises a centrifugal separator having the inlet coupled with the first treatment stage for receiving the first stage treated effluent stream, the treated fluid outlet for providing the second stage treated effluent stream and a particle outlet for providing the combustion particles and the water separated from the treated fluid.

In one embodiment, the centrifugal separator comprises a cylindrical chamber defined by a base plate and an opposing plate coupled by a rim.

In one embodiment, the receiving comprises receiving the first stage treated effluent stream at the inlet which is centrally-located in the opposing plate of the centrifugal separator.

In one embodiment, the providing comprises draining the particles and the water into a sump through the particle outlet in the base plate.

In one embodiment, the providing comprises venting the from the treated fluid outlet in the opposing plate.

In one embodiment, the method comprises locating the particle outlet and the treated fluid outlet radially away from the inlet.

In one embodiment, the second treatment stage comprises at least one of a radial fan and a centrifugal particle separator.

In one embodiment, the method comprises rotating the radial fan comprises a plurality of vanes extending from the inlet towards the rim.

In one embodiment, the vanes taper towards the rim.

In one embodiment, the vanes terminate prior to the rim to define a volute and accelerates the first stage treated effluent stream to be received with the volute.

In one embodiment, the method comprises entraining the combustion particles and the water on walls of the volute to separate the combustion particles and the water from the treated fluid.

In one embodiment, the method comprises providing the particle outlet proximate at least one of the rim and an end of the vane.

In one embodiment, the method comprises providing the treated fluid outlet proximate at least one of the rim and an end of the vane.

In one embodiment, the method comprises rotating the centrifugal particle separator, the centrifugal particle separator comprises a plurality of conduits extending axially proximate the rim to receive the first stage treated effluent stream.

In one embodiment, the method comprises conveying the first stage treated effluent stream through the conduit during rotation to entrain the combustion particles and the water on a wall of the conduit to separate the combustion particles and the water from the treated fluid.

In one embodiment, the method comprises receiving the first stage treated effluent stream at a conduit inlet and venting the treated fluid at a conduit outlet and draining the combustion particles and the water entrained by the wall through the inlet.

In one embodiment, the conduits are formed within an annular body extending along the rim.

In one embodiment, the second treatment stage comprises both the radial fan and the centrifugal particle separator.

In one embodiment, the method comprises conveying treated fluid separated from the combustion particles and the water entrained by the walls of the volute of the radial fan to conduits of the centrifugal particle separator.

In one embodiment, the method comprises dimensioning the vanes and conduits to match a fluid velocity within the volute with a fluid velocity within the conduits.

In one embodiment, the method comprises rotating the centrifugal separator with a drive.

In one embodiment, the method comprises coupling the treated fluid outlet with a third treatment stage for treating the second stage treated effluent stream.

In one embodiment, the method comprises co-axially locating the first treatment stage, the second treatment stage and the third treatment stage.

In one embodiment, the method comprises co-axially surrounding the first treatment stage with the third treatment stage.

In one embodiment, the method comprises receiving the first treatment stage, the second treatment stage and the third treatment stage within a common housing.

In one embodiment, the method comprises dimensioning a tolerance between the inlet and the first treatment stage to be packed by water to provide a rotational seal.

In one embodiment, the first treatment stage comprises a burner and water cooler.

In one embodiment, the third treatment stage comprises an acid scrubbing chamber.

In one embodiment, the method comprises providing the second stage treated effluent gas stream to a base of the acid scrubbing chamber.

In one embodiment, the method comprises draining water from the third treatment stage into the second treatment stage through drain holes in the opposing plate.

In one embodiment, the method comprises conveying the first stage treated effluent gas stream under pressure from the first treatment stage through the second treatment stage.

In one embodiment, the method comprises pumping water received from the particle outlet to at least one of the first treatment stage, the third treatment stage and to a bearing supporting the second treatment stage.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

In order that the present invention may be well understood, two embodiments thereof, which are given by way of example only, will now be described in more detail, with reference to the accompanying drawings, in which:

FIG. 1A illustrates an abatement apparatus according to one embodiment;

FIG. 1B illustrates an abatement apparatus according to another embodiment;

FIG. 2A illustrates a centrifugal separator of the abatement apparatus of FIGS. 1A and 1B in more detail;

FIG. 2B further illustrates a centrifugal separator of the abatement apparatus of FIGS. 1A and 1B in more detail; and

FIG. 2C also illustrates a centrifugal separator of the abatement apparatus of FIGS. 1A and 1B in more detail.

### DESCRIPTION OF THE EMBODIMENTS

Before discussing the embodiments, first an overview will be provided.

Embodiments provide a centrifugal separator for an abatement apparatus. The centrifugal separator assists in the extraction of particulate material (so-called “powder” and/or liquid) present in the effluent stream processed by the abatement apparatus.

The centrifugal separator is a second-stage of the abatement apparatus, interposed between a first-stage primary cooling chamber (typically a weir) and a third-stage acid scrubbing chamber (typically a packed tower) of a gas-fired combustion-type abatement system.

The primary cooling chamber receives, from a combustion chamber, a combusted effluent stream which comprises a treated fluid together with combustion particles. As the treated fluid and combustion particles pass through the primary cooling chamber some of the combustion particles are removed by a liquid (typically water), which cools the combusted effluent stream. The primary cooling chamber outputs the cooled combusted effluent stream as a first-stage treated effluent stream which comprises the treated fluid and remaining combustion particles, as well as water.

In order to further remove combustion particles and water from the cooled combusted effluent stream, the cooled combusted effluent stream is provided to the centrifugal separator. Typically, the centrifugal separator comprises a rotating element. The centrifugal separator then removes further combustion particles and water and exhausts the treated fluid without the removed combustion particles and water as a second-stage treated effluent stream. Accordingly, the second-stage treated effluent stream will have the vast majority of the combustion particles and water removed. This second-stage treated effluent stream is then provided to the third-stage acid scrubbing chamber for further treatment.

### Abatement Apparatus

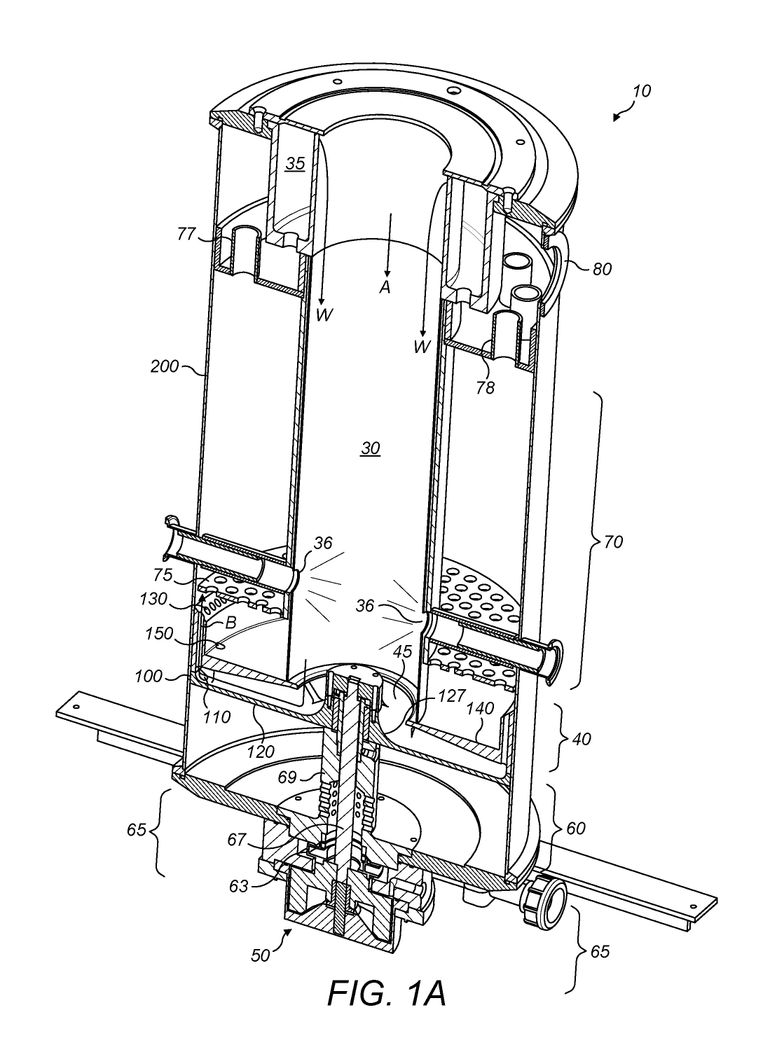

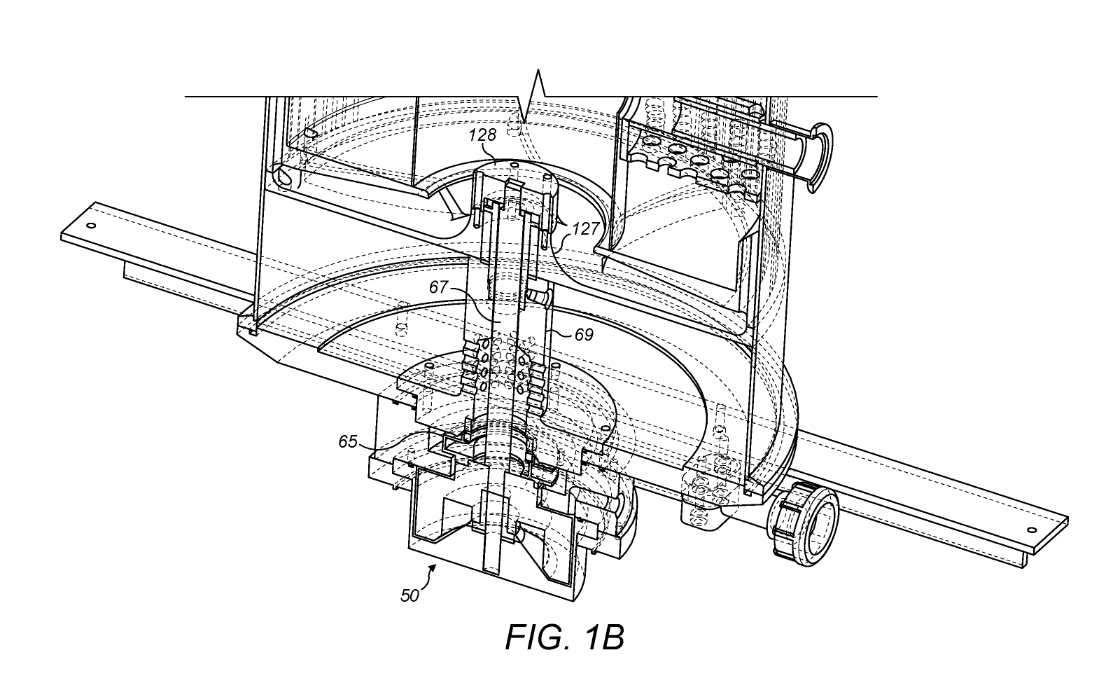

FIG. 1A illustrates an abatement apparatus, generally 10, according to one embodiment with the upper top plate and combustion chamber removed to improve clarity. The abatement apparatus 10 comprises a radiant burner (not shown) which treats an effluent gas stream pumped from a manufacturing process tool, such as a semiconductor or flat panel display process tool, typically by means of a vacuum pumping system (not shown). The effluent stream is received at inlets (not shown). The effluent stream is conveyed from the inlet to a nozzle (not shown) which injects the effluent stream into a cylindrical combustion chamber. Each nozzle is located within a respective bore (not shown) formed in a ceramic top plate (not shown) which defines an upper or inlet surface of the combustion chamber.

### Combustion Chamber

The combustion chamber has sidewalls defined by an exit surface of a foraminous burner element such as that described in EP 0 694 735. The burner element is cylindrical and is retained within a cylindrical outer shell. A plenum volume is defined between an entry surface of the burner element and the cylindrical outer shell. A mixture of fuel gas, such as natural gas or a hydrocarbon, and air is introduced into the plenum volume via one or more inlet nozzles (all not shown). The mixture of fuel gas and air passes from the entry surface of the burner element to the exit surface of the burner element for combustion within the combustion chamber.

The ratio of the mixture of fuel gas and air is varied to vary the temperature within the combustion chamber to that which is appropriate for the effluent stream to be treated. Also, the rate at which the mixture of fuel gas and air is introduced into the plenum volume is adjusted so that the mixture will burn without visible flame at the exit surface of the burner element. The exhaust from the combustion chamber is vented into a primary cooling chamber.

Accordingly, the effluent stream received through the inlets and provided by the nozzles to the combustion chamber is combusted within the combustion chamber which is heated by the mixture of fuel gas and air which combusts near the exit surface of the burner element. Such combustion causes heating of the combustion chamber and provides combustion products, such as oxygen, typically within a range of 7.5% to 10.5% depending on the air/fuel mixture [CH₄, C₃H₈, C4H₁₀], provided to the combustion chamber. This heat and the combustion products react with the effluent stream within the combustion chamber to clean the effluent stream. For example, SiH₄ and NH₃ may be provided within the effluent stream, which reacts with O₂ within the combustion chamber to generate SiO₂, N₂, H₂O, NOₓ. Similarly, N₂, CH₄, C₂F₆ may be provided within the effluent stream, which reacts with O₂ within the combustion chamber to generate CO₂, HF, H₂O. The combusted effluent stream exhausts from the radiant burner and comprises the treated stream, together with combustion particles.

### Primary Cooling Chamber

The combusted effluent stream passes in direction A from the radiant burner to the primary cooling chamber 30. A weir 35 provides a water curtain which travels in the direction W down an inner surface of the primary cooling chamber 30. Typically, the water within the weir 35 is configured to flow tangentially so that the water curtain also flows tangentially or rotates circumferentially around the inner surface of the primary cooling chamber 30 as it travels in the direction W. The water curtain helps to cool the combusted effluent stream as it travels in the direction A. Spray nozzles 36 are also provided which further ejects water to cool the combusted effluent stream. Some combustion particles are entrained or captured by the water from the water curtain and/or the spray nozzles 36. However, the cooled combusted effluent stream exhausted from the primary cooling chamber 30 now also contains water and water droplets.

### Centrifugal Separator

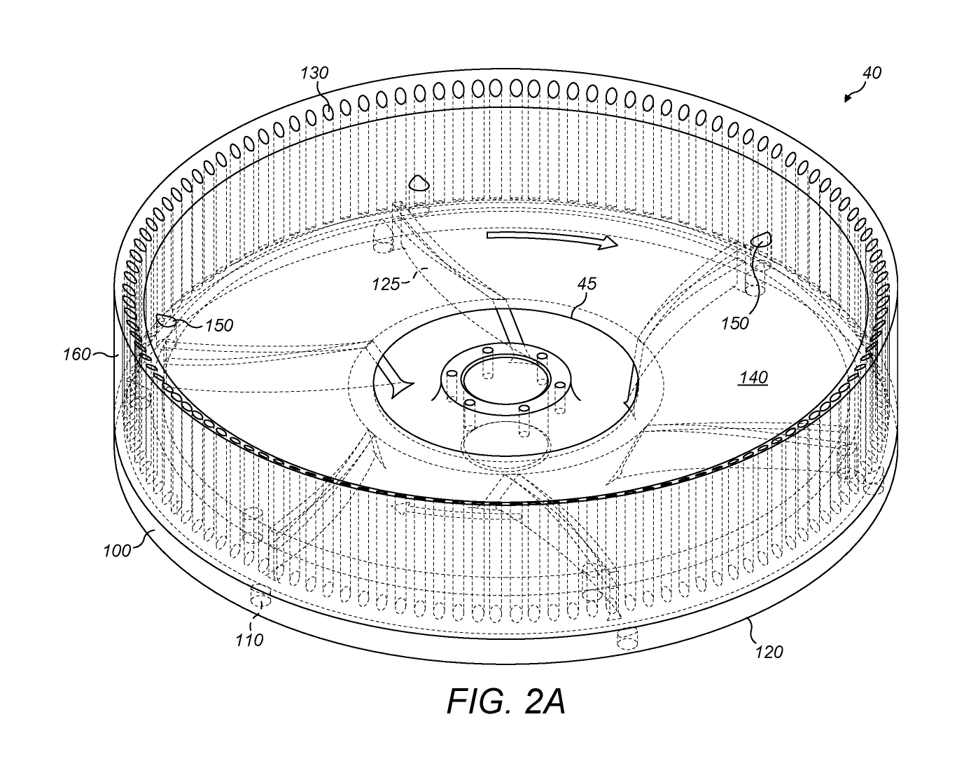

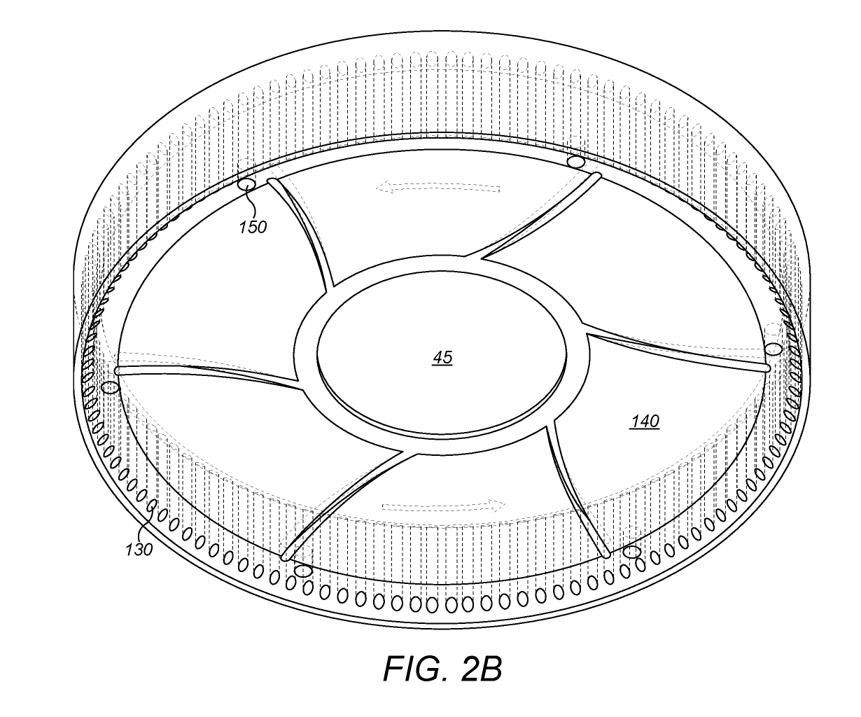

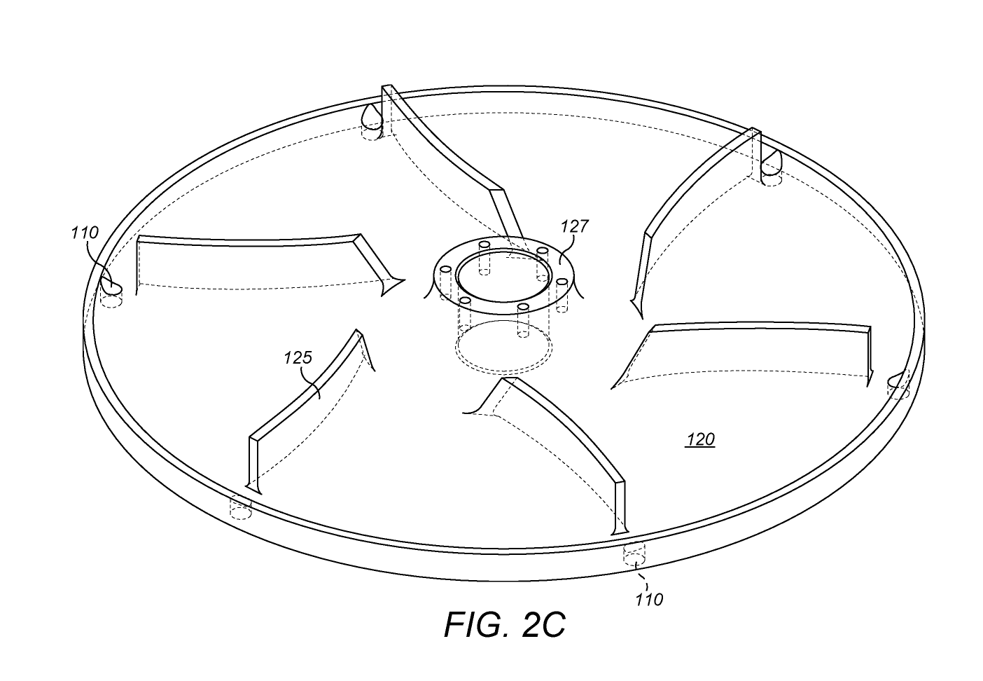

The cooled combusted effluent stream is received by the centrifugal separator 40, which is illustrated in more detail in FIGS. 2A to 2C. In particular, an inlet 45 is provided through which the cooled combusted effluent stream is received by the centrifugal separator 40, including the water from the water curtain, the spray from the spray nozzles 36 and any already entrained combustion particles within the cooled combusted effluent stream and the water.

The centrifugal separator 40 is operable to rotate with respect to the other parts of the abatement apparatus 10 within a common housing 200. The dimension of the centrifugal separator 40 is selected to provide a reasonable fit in the common housing 200 to discourage fluid bypassing the centrifugal separator 40 via drain holes. The clearance between the end of the primary cooling chamber 30 and the top of an opposing plate 140 is dimensioned to be small enough to minimize recirculation which otherwise spoils the suction generated by the centrifugal separator 40. Water flow from the water curtain packs this clearance, further reducing leakage.

The centrifugal separator 40 is rotated by a drive (not shown) coupled to a motor coupling 50 and has a pair of opposing plates 120, 140 between which is a radial fan component which feeds a centrifugal particle separator upstanding from one of the opposing plates. In overview, the stream received at the inlet 45 undergoes a two-phase separation process to remove combustion particles and water from the cooled combusted effluent stream to leave the treated stream for subsequent processing. The water present in the cooled combusted effluent stream assists in removal of the combustion particles. Accordingly, the effluent exiting the centrifugal separator 40 will have most of the water and combustion particles removed.

In particular, as a first phase, the cooled combusted effluent stream is accelerated by vanes 125 of the radial fan component from the inlet 45 towards a rim 100. This initial action performs an initial separation since many of the combustion particles and much of the water is then entrained by an inner surface of the rim 100 and drains into a sump 60 via drain holes 110 provided in a base plate 120 of the centrifugal separator 40. Hence, by placing the primary cooling chamber 30 upstream of the centrifugal separator 40, water droplets from quench cooling in the primary cooling chamber aid the particle capture in the centrifugal separator 40.

The centrifugal separator 40 comprises the base plate 120 and the opposing plate 140 which is spaced away from the base plate 120 to create a chamber, void or space between the plates 120, 140 within which the effluent stream flows. The opposing plate 140 is provided with the inlet 45 at its centre which receives the effluent stream from the cooling chamber 30. The base plate 120 and the opposing plate 140 are fused together at the periphery or rim 100. Between the plates 120, 140 are vanes 125 which urge the effluent stream from the centre to the periphery, thereby creating a reduction in pressure at the inlet 45. In this example, the vanes are arranged tangentially with respect to the inlet 45 and are curved and taper towards the rim 100. However, it will be appreciated that other arrangements of vanes 125 may also be utilized. As best illustrated in FIG. 2C, the vanes 125 extend only partially towards the rim 100, leaving a clear passage or volute within which the combustion particles and water may gather.

The positive pressure of the effluent stream from the primary cooling chamber 30 together with the acceleration of the effluent stream by the radial fan component causes a flow of the effluent stream once it is received within the volute adjacent the inner surface of the rim 100 to flow in the direction B into a centrifugal particle separator. Adding the radial fan element provides for a sub-atmospheric inlet and avoids the requirement for a volute housing to feed the centrifugal separator 40.

The centrifugal particle separator is formed by an elongate annular body or rim 160 extending from the opposing plate 140 within which is provided a plurality of the conduits 130. The conduits 130 together form a centrifugal particle separator which further removes combustion particles and water from the effluent stream. As can be seen, these conduits 130 have a long and narrow aspect ratio. As the combustion particles, water and fluid travel through a conduit 130 that conduit acts as a centrifuge, centrifugal acceleration of the entrained particles in the stream causes them to be thrown to the walls of the conduits 130. Entrained water droplets are also thrown to the walls of the conduits 130 and help to wash the combustion particles down. The entrained material then flows back down the conduit 130 under gravity and back towards the volute adjacent the inner surface of the rim 100 where it can then drain through the drain holes 110 and into the sump 60. The fluid, substantially free of combustion particles and water droplets exit at the top of the plurality of conduits 130 and pass into the acid scrubbing chamber 70.

As illustrated in more detail in FIG. 1B, the base plate 120 also comprises a central hub 127 by which the centrifugal separator 40 is rotatably mounted on a column 69 housing a driveshaft 67. The driveshaft 67 is driven by a motor (not shown) via a motor coupling 50. The column 69 houses the driveshaft 67 which acts to drive the centrifugal separator via a rotor coupling 128 attached to the hub 127. In this arrangement, the motor coupling 50 is for a magnetic drive.

### Acid Scrubbing Chamber

The effluent stream exiting the centrifugal separator 40 then passes into an acid scrubbing chamber 70 via a perforated support plate 75. The acid scrubbing chamber 70 is filled with packing materials (not shown) supported by the perforated support plate 75. Water is supplied to a sieve plate 78 via risers from the sump 60 and irrigates the packing materials via a plurality of small holes in the sieve plate 78. The water flows under gravity over the packing material and towards the perforated support plate 75. The treated effluent stream is then vented via conduits 77 and exhausted from the abatement apparatus 10 via an exhaust outlet 80.

The packed tower 70 entrains any residual particles, which are washed out by the water, through the perforated support plate 75 and are received by the upper plate 140 of the centrifugal separator 40. Drain holes 150 are provided to drain back into the chamber within which the radial fan component is located. Water also drains into the conduits 130 in order to help remove any materials entrained on the walls of the conduits 130.

### Sump

The sump 60 receives water and combustion particles and utilizes a centrifugal water pump 65 which is also powered by the motor coupling 50 to provide water to the weir 35, the nozzles 36, as well as to lubricate the bearings for the centrifugal separator 40.

In particular, the column 69 also forms the inlet of the centrifugal water pump 65 which is mounted in the bottom of the sump 60. This pump 65 takes a working fluid, for example water, from the sump 60 and distributes it to the various parts of the abatement apparatus 10 that require a fluid service. For example, it provides for a water curtain between the combustion chamber and the inlet 45 of the centrifugal separator 40, it irrigates the packing of the acid scrubbing chamber 70, it lubricates the bearing supporting the centrifugal separator 40 and may also supply one or more spray nozzles 36 for cooling the stream from the combustion chamber within the primary cooling chamber 30. It may also serve to periodically discharge a portion of the working fluid to drain. The centrifugal water pump 65 may be directly driven from a driveshaft equipped with a rotary seal (which would be located at position 63) to prevent fluid leakage. Alternatively, and as shown in the figure, the centrifugal water pump 65 may be magnetically coupled without the requirement of a rotary seal. In both embodiments, one drive system, for example an electric motor, drives both the water pump 65 and the centrifugal separator 40. Thus, depression of the combustion chamber pressure, particle scrubbing and working fluid circulation is conveniently achieved in a single abatement apparatus 10.

The radiant burner, primary cooling chamber 30, centrifugal separator 40 and packed tower 70 and the sump 60 are coaxially co-located within a common housing 200.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

1. An abatement apparatus for treating an effluent stream from a semiconductor processing tool, comprising:
a first treatment stage operable to combust said effluent stream to provide a combusted effluent steam and to treat said combusted effluent stream with water to provide a first stage treated effluent stream comprising treated fluid together with combustion particles and water; and
a second treatment stage operable to receive said first stage treated effluent stream at an inlet and to separate centrifugally at least some of said combustion particles and said water from said treated fluid which is provided at a treated fluid outlet as a second stage treated effluent stream.

2. The apparatus of claim 1, wherein said second treatment stage comprises a centrifugal separator having said inlet coupled with said first treatment stage for receiving said first stage treated effluent stream, said treated fluid outlet for providing said second stage treated effluent stream and a particle outlet for providing said combustion particles and said water separated from said treated fluid.

3. The apparatus of claim 2, wherein said centrifugal separator comprises a cylindrical chamber defined by a base plate and an opposing plate coupled by a rim.

4. The apparatus of claim 2, wherein said centrifugal separator comprises at least one of a radial fan and a centrifugal particle separator.

5. The apparatus of claim 4, wherein said radial fan is rotatable and comprises a plurality of vanes extending from said inlet towards said rim.

6. The apparatus of claim 5, wherein said vanes taper towards said rim.

7. The apparatus of claim 5, wherein said vanes terminate prior to said rim to define a volute within which said first stage treated effluent stream accelerated by said vanes is received.

8. The apparatus of claim 7, wherein walls of said volute are configured to entrain said combustion particles and said water to separate said combustion particles and said water from said treated fluid.

9. The apparatus of claim 5, wherein said particle outlet is provided proximate at least one of said rim and amend of said vane.

10. The apparatus of claim 5, wherein said treated fluid outlet is provided proximate at least one of said rim and an end of said vane.

11. The apparatus of claim 4, wherein said centrifugal particle separator is rotatable and comprises a plurality of conduits extending axially proximate said rim to receive said first stage treated effluent stream.

12. The apparatus of claim 11, wherein a wall of said conduit is configured to entrain said combustion particles and said water to separate said combustion particles and said water from said treated fluid during rotation of said conduit as said first stage treated effluent stream is conveyed therethrough.

13. The apparatus of claim 11, wherein each conduit comprises a conduit inlet for receiving said first stage treated effluent stream and a conduit outlet as said outlet for venting said treated fluid, said combustion particles and said water entrained by said wall draining back through said inlet.

14. The apparatus of claim 11, wherein said conduits are formed within an annular body extending along said rim.

15. The apparatus of claim 4, wherein said second treatment stage comprises both said radial fan and said centrifugal particle separator.

16. The apparatus of claim 4, wherein treated fluid separated from said combustion particles and said water entrained by said walls of said volute of said radial fan is conveyed to conduits of said centrifugal particle separator.

17. The apparatus of claim 1, wherein a tolerance between said inlet and said first treatment stage is dimensioned to be packed by water to provide a rotational seal.

18. The apparatus of claim 3, wherein said opposing plate comprises drain holes operable to drain water from a third treatment stage into said second treatment stage.

19. The apparatus of claim 18, comprising a pump operable to pump water received from said particle outlet to at least one of said first treatment stage, said third treatment stage and to a bearing supporting said second treatment stage.

20. A method of treating an effluent stream from a semiconductor processing tool, comprising:
combusting, at a first treatment stage, said effluent stream to provide a combusted effluent steam and treating said combusted effluent stream with water to provide a first stage treated effluent stream comprising treated fluid together with combustion particles and water; and
receiving, at a second treatment stage, said first stage treated effluent stream at an inlet and separating centrifugally at least some of said combustion particles and said water from said treated fluid and providing said treated fluid at a treated fluid outlet as a second stage treated effluent stream.
